(19) United States
(12) Patent Application Publication
(10) Pub. No.: US 2012/0330946 A1
(43) Pub. Date: Dec. 27, 2012

(54) INTUITIVE, CONTEXTUAL INFORMATION SEARCH AND PRESENTATION SYSTEMS AND METHODS

(76) Inventors: PABLO D. ARREDONDO, Palo Alto, CA (US); Roy Wang, Los Altos, CA (US)

(21) Appl. No.: 13/019,373

(22) Filed: Feb. 2, 2011

Related U.S. Application Data
(60) Provisional application No. 61/301,131, filed on Feb. 3, 2010.

(51) Int. Cl. G06F 17/30

(52) U.S. Cl. 707/728; 707/E17.014

(57) ABSTRACT

Tags representing characteristic terms in a set of matter-specific local documents, such as an accumulating litigation or medical record, are identified and used to evaluate the relevance to a user of each of a set of global, generally accessible documents. User-entered keywords and other parameters may also be incorporated into the search strategy to increase the relevance of returned documents.

### CROSS-REFERENCE TO RELATED APPLICATIONS

This application is related to and claims priority of U.S. Provisional Patent Application 61/301,131, “Systems and Methods for Efficient and Intuitive Professional Search and Record Management,” filed 3 Feb. 2010.

### BACKGROUND ART

Research is an essential task for many professions. Because the volume of material professionals may sometimes need to analyze is often far greater than what they could read in a lifetime, search tools play a crucial role. For decades, professionals have relied on search engines to discover relevant information. While these software tools often help to locate relevant materials, their use is often cumbersome and requires users to forage through multiple databases and construct long Boolean queries to locate information most relevant to the matter at hand. Even after such foraging and query-constructing, these users must often sift through results in hopes of finding those returned cases more applicable to the pending litigation.

Services involving the collection, indexing and presentation of records and other types of documents in various professional fields have been available for a long time. In the legal field, as just one example, materials such as court opinions, articles, patents, briefs, and other forms of legal records have been available for decades. Two prominent American providers with extensive databases of legal information are LexisNexis and Westlaw, while various other companies offer similar products around the world not only for legal professionals, but also for medical practitioners, scientists, etc.

Considering the legal world by way of example, while these services allow consumers of legal materials to locate relevant materials, the process is often cumbersome and requires users to manually come up with ideal search terms, often expressed as keywords in Boolean terms, in order to locate the records most relevant to the matter at hand. Similarly, there are known services to aide electronic mandatory document disclosure (“discovery”) and review of documents collected and produced for litigations. These services also require users to manually construct ideal search terms in order to return relevant documents in its databases. Attorneys must then go through result lists and try to find cases and other documents that best fit their particular needs given a particular matter at hand.

One of the drawbacks of such known systems is that the users must sift through potentially large numbers of “hits” to find those that are most relevant. This often requires an iterative refinement and narrowing of search terms just to get the number of documents down to a manageable level. Of course, every narrowing of search terms increases the likelihood that relevant documents will be excluded; moreover, even slight deviations of search terms often result in widely different and often irrelevant returns. This procedure also often requires the user to have special knowledge of the case matter at hand to iteratively construct better search terms in the context of a particular litigation or legal matter.

It is well known and well documented that the consumers of these services, generally lawyers and paralegals at firms and public agencies, have been frustrated with the lack of intelligence in these systems in finding relevant materials in a quick and robust manner. With the increasing proliferation of electronically available legal materials, the need for a more intelligent and intuitive legal record management system becomes more and more important. Time savings and improvements in the user experience for each query run can easily result in large savings in time and thus legal fees and costs, particularly for document-intensive high-stake litigation cases. Just as importantly, legal search tools that provide more intuitive results decrease the chance that an attorney will fail to discover a case that might help their client.

The general problem—as in almost all search technology—is therefore to come up with a system and search method that as fast as possible finds and correctly identifies and intuitively presents to a user the greatest possible number of most relevant documents according to as correct as possible an interpretation of the notion of “relevance” to the context of the user's actual needs. Note that the concept of contextual relevance goes well beyond and complicates the simple notions of “false negatives” and “false positives,” which are difficult enough hurdles for search routines to clear.

Before the advent of such modern search engines as Google, almost all online and database searching was controlled completely by keywords that the user entered. This is still the case for many search engines. Given a set of keywords, the search system then searches for all documents that have those terms, usually with some assumed Boolean operator such as AND between the terms. In other words these systems look for documents that have all the terms, with no regard for other user preferences or needs. Although simple, they lack context, such that the documents may end up being presented in an almost random order, such as in the order the system found them. As everyone who has ever done such a search realizes, failure to craft just the right query typically results in a large number of both false negatives and false positives. For example, keyword-based search tools may return as relevant documents that happen to mention a keyword only in passing, or in a different sense than is relevant to the user.

Even today, if one enters all but very specialized keywords into a standard search engine such as Google, one is still presented with thousands if not millions of possible documents to review. Users are thus at the mercy of their ability to construct the right search query and must examine a large number of irrelevant and therefore time-wasting documents.

Most know systems that search patent databases, such as the online search utility of the U.S. Patent and Trademark Office (USPTO) or the European eSpace system, exploit the structured nature of patents (all have text corresponding to categories such as “Title,” “Inventor,” “Claims,” “Applicant/Assignee,” etc.) to allow the user to narrow the scope of a search. Using corresponding field classifiers, the user then constructs a Boolean expression that the search engine then follows. For example, in the current USPTO system, a query such as “AN/Stanford AND SPEC/”search engine” will return the list of patents that include the phrase “search engine” somewhere in the specification/description and that show Stanford as the assignee of the patents. These systems are not as open-ended as Internet search engines, and it's more likely that return documents are relevant to the user, but this is primarily because of the limited scope of the database being searched (everything is by definition a patent or perhaps patent application), and the result is still exclusively dependent on the quality of the query that the user submits.

One way to estimate relevance in the context of a web search is to measure popularity. A breakthrough by Google, for example, was to capture the “wisdom of the crowd” by ranking more highly those websites that are most frequently accessed or to which the most other sites link. One problem of such a “wisdom of the crowd” approach is that the crowd knows nothing about the particular context of the user. For example, a simple search on the term “non-obviousness” in any known legal database may return thousands of “hits,” many of which will refer to the “KSR v. Teleflex” case. For one thing, the attorney probably already knows about this case; for another, almost all of the returned references will be unrelated to the attorney's question about how a particular judge interpreted this concept in a case involving a particular technology. Of course, the attorney could then iteratively refine his search query to eliminate more irrelevant cases, but this then gets back to the drawbacks of keyword-based searching.

Some known search systems augment or substitute the “wisdom of the crowd” approach with a “wisdom of the user” approach. In these systems, user behavior is taken into account to help refine a search. For example, if a user frequently accesses certain sites, then these systems assume that they are of particular relevance to the user and will rank more highly other sites with similar content, with similarity being measured using any of a large number of metrics.

One other shortcoming of systems that measure relevance in whole or large part according to the query structure (keyword selection) or “popularity” is that, from the standpoint of a professional dealing with a unique matter, they may reflect a bias of the crowd or the bias or of the user himself. This of course also affects the “wisdom of the user” methodology. In many instances, the wisdom of the crowd or the wisdom of the users may therefore lead away from, rather than toward, the results a professional will find most relevant for a specific matter. For example, the wisdom of the crowd does not fully meet the needs of attorneys, physicians and other professionals whose client/patient may have unique needs, such that lesser known or lesser-cited cases are in fact better for their purposes. For example, an attorney working on a patent case concerning a specific technology like polymerase chain reaction (“PCR”) will be interested in seeing other PCR cases even if they have not been widely cited.

In the field of legal search tools, the company Factcase, Inc., of Washington, D.C., USA markets a product that examines the frequency of citation of common law cases and ranks relevance accordingly when displaying results to a user. Thus, Fastlaw implements a form of the “wisdom of the crowd,” although in the limited area of searching for legal documents.

U.S. Pat. No. 7,610,279 (Budzik et. al) discloses a system that evaluates relevance not simply based on keywords or popularity, but on a measure of relevance to a document that the user has open on his current screen. In other words, systems such as Budzik rely on the “wisdom of the immediate document” for purposes of carrying out a search. One obvious disadvantage of such an approach is that a single active document will seldom accurately reflect more than a very narrow aspect of the context of a complex matter. Further, because litigation is often conducted by teams of attorneys each of which will only access a fraction of a litigation record, limiting the information coupled to the search engine to what a given attorney has open on his computer or has recently accessed will lead to the ignoring of relevant information (i.e. that fraction of the litigation record that a given attorney does not have open.

The effect of user-bias is akin to the “blind men and the elephant” parable in which each blind man touches a different part of an elephant and thus has a different understanding of the matter at hand while all fail to see the matter as a whole. Similarly, each attorney has open on his screen only a fraction of a litigation record and a user-context based search that focuses on the user's current work environment (such as currently open document) will fail to utilize the litigation record as a whole.

A more recent attempt to improve search capabilities is now being marketed by the LexisNexis corporation under the name “Lexis for Microsoft Office” and enables users to access the features of the well-known LexisNexis document search from within various Microsoft Office software products. Three features of this Lexis for Microsoft Office product are “Search,” “Background” and “Suggest.” The Search feature allows a user to click on some part of an on-screen document, which acts as input data for a search of the legal content of the LEXIS-NEXIS system, the Internet, and any internal database that has been linked in. Results from all of these sources are then displayed in a window next to the active document.

The “Background” function provides background information on “entities” such as people, companies, organizations and legal cases mentioned in the text of the active document. It also automatically indexes the active document with hyperlinks into the information resources that were used in the search. When the user clicks on one of these links, corresponding information is displayed in a side pane. Using the “Suggest” function, the user manually highlight text in the active document, and this launches a search that pulls up information from the various data resources according to some notion of relevance. This is also displayed in a side pane.

One further feature of the Lexis for Microsoft Office product is that it interacts with a SharePoint server to allow subscribers to store, organize and share documents from a SharePoint site, which can also act as one of the internal database resources in which the Lexis for Microsoft Office product searches.

An essential feature of the Lexis for Microsoft Office system is that there is an active document at the center of the entire process. In other words, although the system accesses documents from many different sources, the scope of the search is limited by information found in the immediately available document. Because of this, if the user doesn't see a particular term or phrase or case name in the active document, then the system is likely to exclude this potentially highly relevant concept from its search. Although more sophisticated, the Lexis for Microsoft Office system is therefore similar to the Buzdik system in that it represents an implementation of the concept of the “wisdom of the open document,” with its corresponding shortcomings.

### SUMMARY

Tags representing characteristic terms in a set of matter-specific local documents, such as an accumulating litigation or medical record, are identified and used to evaluate the relevance to a user of each of a set of global documents that are generally accessible but have a priori unknown relevance to the current matter. User-entered keywords and other parameters may also be incorporated into the search strategy to increase the relevance of returned documents. At least one tag is extracted from the local documents, each tag being characteristic of the current matter. The global documents are then searched and an estimate is computed of the relevance of each global document as a function of a measure of a degree inclusion of the tags. Indications of the global documents having the highest estimates of relevance are then presented to the user. The local documents include at least one document not actively and directly being processed by the user.

### BRIEF DESCRIPTION OF DRAWINGS

FIG. 1 illustrates the major components of most embodiments of the invention.

FIG. 2(A) illustrates the growth of a collection of local documents.

FIG. 2(B) demonstrates the diverse compilation and storage of a collection of local documents.

FIG. 3 illustrates ranking of a case that closely matches with the collection of local documents.

FIG. 4 shows one embodiment that handles a user-specified query in accordance with a specific collection of local documents.

FIG. 5 shows one embodiment of local document matching in conjunction with user query matching.

FIG. 6 is an illustration of how, without any user query, the awareness of the local documents aids in organization and ranking of a global documents of legal opinions.

FIG. 7(A) depicts return results from a keyword query in the context of a collection of local documents concerning a Stanford v. Roche case with a patent claim in the biotechnology area before the N.D. Cal. federal court.

FIG. 7(B) depicts return results from a keyword query in the context of a collection of Berkeley local documents comprising a University of California complaint addressing a non-patent claim in an unknown technical field before the N.D. Cal. federal court.

FIG. 8(A) depicts return results from a query for a common word obtained without knowledge of the collection of local documents.

FIG. 8(B) depicts return results from a query for a common word in the context of a Stanford collection of local documents concerning a Stanford v. Roche case with a patent claim in the biotechnology area before the N.D. Cal. federal court.

FIG. 8(C) depicts return results from a query for a common word in the context of a Berkeley collection of local documents a collection of local documents comprising a University of California complaint addressing a non-patent claim in an unknown technical field before the N.D. Cal. federal court.

FIG. 9 shows a web query embodiment where the user enters a key word query and specifies a selection of a collection of local documents, and then the system retrieves results in accordance with both the user-specified query and the selected collection of local documents.

FIG. 10 shows a machine architecture for a computer on which the various embodiments disclosed herein may be carried out.

### DETAILED DESCRIPTION

As will become clear, one aspect of embodiments of the invention is that rankings of “hits” of legal (or other) cases, statutes, journal articles, other document types, etc., may be based on the unique nature of the client and the unique nature of the matter at hand. One unique aspect of the invention is that it couples a search query to the context of a particular matter, such as litigation, relieves the attorney of most or all of the burden of having to input into the search engine parameters that have already been entered or identified in an existing collection of relevant documents.

The invention is described below primarily in the context of legal work. This is by way of example only and as will be apparent, the invention may be applied to advantage in any other area where there is a body of documents in a field available to a user that can be used for automatic extraction of information having unique or at least typically characteristic words and phrases relevant to a specific case or matter, and that can augment a search of non-user-specific documents. One of the many other possibilities would be in the medical field, where, instead of a client there is a patient or study population, and instead of a litigation (for example) record there is a patient history or research record. Almost any type of professional who needs to search a potentially large universe of documents to find those most uniquely relevant to a matter at hand.

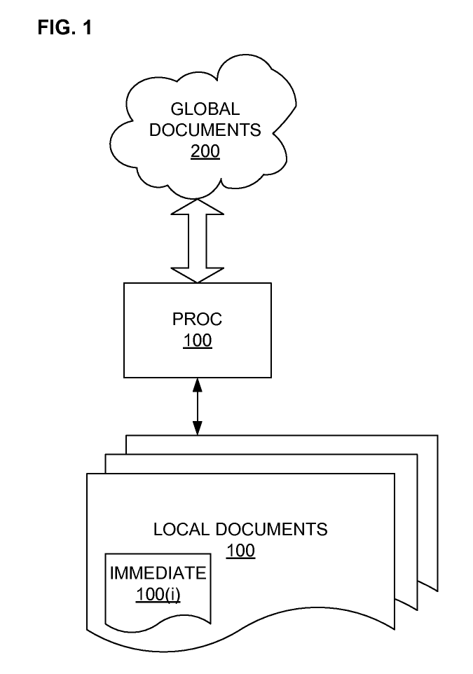

As FIG. 1 illustrates, most embodiments of the invention, a processing system 800 accesses, typically over one or more networks 808, some global body of documents 200, a collection of local documents 100, and one or more “immediate” documents 100(i) that a user is currently accessing. “Global” and “local” do not necessarily refer to any physical location and need not be on a single server or even network. Here, “local” documents are those that are specific to or associated with a matter (such as a litigation) at hand, whereas “global” documents are those that are not specific to the matter. In other words, local documents are of interest primarily to those working with what they relate to, whereas global documents are typically accessible to outsiders and have more general interest. These concepts will become clearer from the explanation below, but consider one short example:

An attorney sitting at his terminal is working on a draft brief (which may comprise several files, such as the main text and separate documents for appendices, notes, etc.), and has a draft open on his screen. This brief would be the “immediate document.”

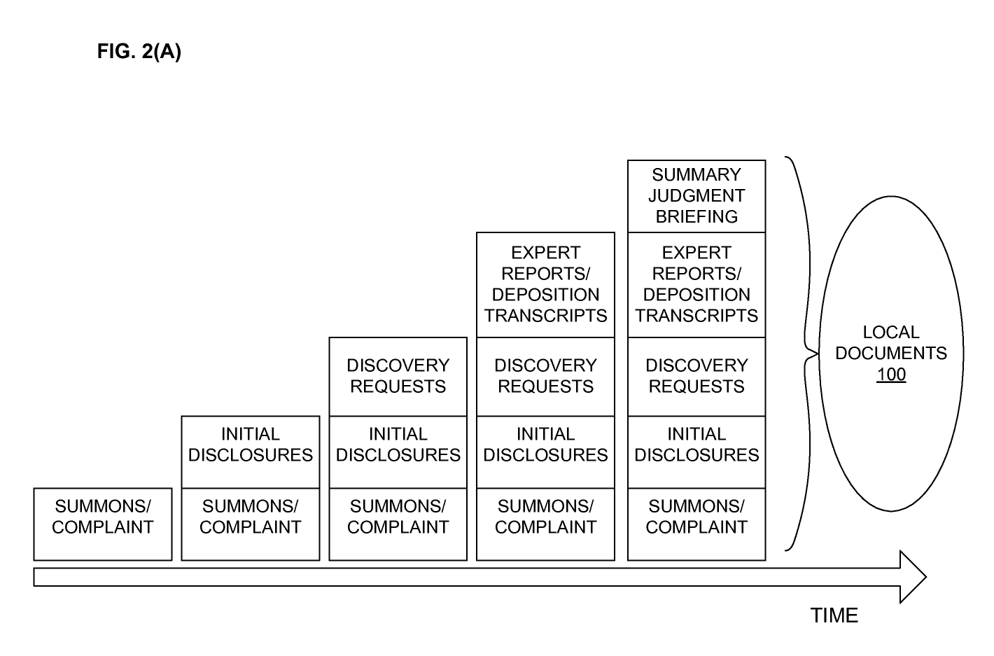

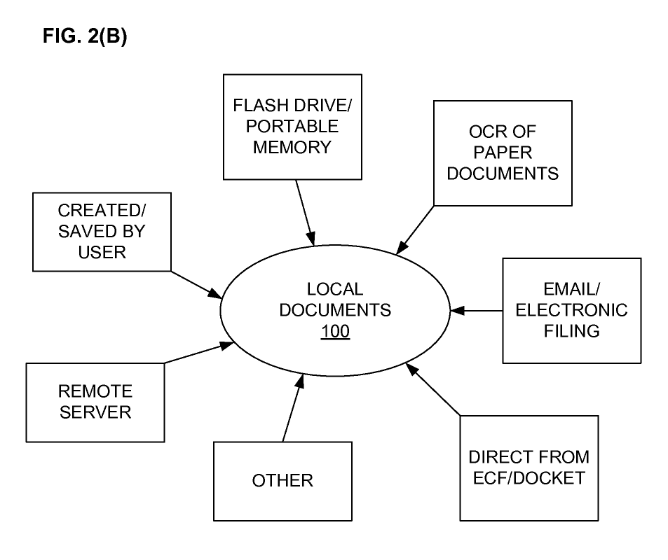

The attorney's firm's server(s) stores, for example in folders or a network-accessible document storage service, or otherwise can give access to, copies of other attorneys' documents relating to the matter, scanned-in copies of an original summons or complaint, initial disclosures, opposing counsel's correspondence, court correspondence, expert reports and deposition transcripts, court orders, etc. Related primarily to the matter at hand, these comprise the “local” documents. As FIG. 2(A) illustrates, this local document collection 100 will typically change and grow over the course of handling a matter. As FIG. 1 illustrates, the immediate documents 100(i) will typically be or become a subset of the local documents 100. Note, moreover, that the collection of local documents will often include documents generated by more than one user, yet their contents can aid in improving search relevance for all users. For example, where the invention is used as a litigation aid, highly significant tags generated by documents from one attorney may, depending on the embodiment, increase the relevance of found documents for another user.

The attorney's computer is preferably also configured to access external databases or sites that have possibly relevant documents but that are not necessarily related specifically to the matter at hand. One example is the U.S. Public Access to Court Electronic Records (PACER) system, which is an electronic public access service that allows users to access and download case and docket information from U.S. federal appellate, district and bankruptcy courts. PACER documents would in this example be among the “global documents.”

In the context of this invention a “document” is any is any defined set of digitally encoded information that can be parsed by machine to identify the presence of given patterns. In most cases, the digitally encoded information will be words, numbers, symbols, etc., but embodiments of the invention could be configured using known techniques to recognize even images, chemical or mathematical formulas, electronic circuits, Chinese characters, etc. Except where the word “word” clearly must be referring to actual language words expressed with alphabetical symbols, “word” is used here simply for the sake of succinctness to indicate all such possibilities. Examples of documents include those stored originally or directly in digital form, such as Microsoft Word files or files created by data input programs, Internet site pages, etc., as well as those that are originally in non-digitized form but that have been digitized using, for example, optical character recognition.

Example embodiments recognize that the consumer of legal materials should not have to bear the bulk of the burden of constructing ideal record queries, and that the legal context surrounding the query should be used as much as possible to aid and simplify the consumer's involvement in record management. By way of example, the advantages of the disclosed example embodiments may be achieved through a novel coupling of ranking algorithms (see below) in a legal search engine (for common-law cases, statutes, etc.) to the collection of local documents 100 of the particular litigation for which the search is being conducted.

As legal practitioners will know, a specific litigation matter can be encoded in various ways such as by reference to the docket number issued by the Court or the specific client matter number created internally by a law firm. When an associate attorney walks into a coworker's office and asks “What case are you working on?” she is usually referring to, for example, to a specific litigation or transactional matter, which is typically defined by the documents it involves.

Certain conventions as to legal documents assist in the automated identification of key sequences that can be readily converted by the processing system 800 into tags that can be associated algorithmically to the collection of local documents 100. This is because many categories of legal documents, or at least many aspects of them, lend themselves to automated recognition of semantic concepts in a matter such as litigation. This aids the growth of the collection of local documents 100, as metadata tagging can be automated and can augment an otherwise unstructured collection of legal materials. For instance, a legal complaint generally follows a customary format, where the case number, the court name, date of filing, the name of the assigned judge, the causes of action and the jurisdiction information are placed toward the front of the complaint, or marked with headings or prominent font types. Knowing the structure of a complaint, the processing system 800 can parse (if necessary) and build automated classifiers that analyze and characterize the complaint and derive the information from the document and assign metadata tags to this piece of the litigation's collection of local documents 100. This is explained more below.

The automatic tagging of portions of the collection of local documents 100 does not have to be perfect. Example embodiments allow for probabilistic outputs of the classifiers. As one alternative, instead of or in addition to automatic extraction of tags, users could enter the tag information may manually in the course of building the collection of the litigation's collection of local documents, or in the course of building the total collection of materials in the litigation record management system.

Contextual learning as in this invention is applicable to more than just the particular types of legal documents discussed in examples here; rather, it is equally applicable to a variety of legal records, including patents learned/known to be the subject matter of a current litigation matter, contracts learned/known to be relevant to the case, or documents already otherwise identified to be relevant to the case. Therefore, without any foraging or complex Boolean expressions—indeed with no search term at all—a small fragment of a collection of local documents 100 can generate a list that appears as though it were “sorted” by a lawyer who has become knowledgeable about the case.

As an example of one embodiment where no search queries need be run at all, one prototype of the invention could identify Stanford-related cases over non-Stanford cases, patent cases over non-patent cases, biotechnology patent cases over non-biotechnology patent cases, while reducing the ranking scores of state cases to low ranking scores, when the collection of local documents 100 starts with a litigation complaint about alleged infringement of a biotechnology patent where Stanford is a party. In contrast, when Berkeley was indicated as a party, the same search yielded a different list: Berkeley cases were identified as being most highly relevant and were presented on top. Thus, the result was that the “best cases”—not for the crowd, or the user, but for the case matter—were brought to the top of the information pile to gain the attention of the query requester.

The present example embodiments recognize that attorney users work under the constant expectation that important precedents are not to be missed. In the age of explosive growth of digital content on the web that is searchable, an inexperienced user could easily miss important precedents that are otherwise caught by a lawyer who is more senior or who has more institutional knowledge about the matter at hand. Various embodiments of the invention reduce this risk. For example, the processing system 800 could be programmed to follow a default rule that cases from the same judge on the same technical subject matter are given higher weight, that is, are ranked as being more important. Another example rule could be that all cases about the same patent number(s) as the one(s) in the collection of local documents 100 should be highly ranked and returned to the user.

According to one aspect of embodiments of the invention, the processing system 800 executes a software routine that analyzes the collection of local documents 100 into a list of multiple tags. For example, jurisdiction of the case as a whole, the patent numbers of the patents being litigated, the presiding judge's name, the causes of actions, the technology area (for example, PCR, semiconductor fabrication, medical devices, computer virtualization, etc.) could all be suitable tags. This analysis of a specific collection of local documents 100 can be triggered manually by the user or can occur automatically whenever new information is entered into the collection of local documents 100. For each of the tags, the system may then apply a user-specified search on a filtered set of data based on the tag, such as only cases dealing with the same technological matter. The system may assemble the top N returns from each of different branches of the tag searches and present some number of these relevant case returns to the user. Using an embodiment such as this, the user may nearly effortlessly gather a minimal set of cases of high relevancy and the risk of missing important precedents is minimized.

### Local Documents

See FIG. 2(A) and continue with the example in which the invention is being used to aid one or more litigation attorneys. As mentioned above, the local documents 100 may begin small, for example with an electronic or otherwise scanned-in and readable copy of copy of the summons and complaint that initiate the litigation. The collection of local documents 100 may then grow as the litigation progresses. For example, and without limitation, for specific litigation Matter X, the local document collection 100 might grow to contain discovery requests exchanged by the parties in Matter X, the expert reports generated in Matter X, the transcripts from depositions taken in Matter X, the transcripts from discovery hearings or trial, counsels' correspondence, attorney notes, etc.

FIG. 2(B) illustrates how the local document collection 100 can be fed in a variety of ways including through the scanning and optical character recognition (OCR) of paper documents, access from an online docket, access from a remote server, uploaded from a flash drive, uploaded from an email. How the local document collection 100 is fed does not affect the performance on the example embodiments. It is also not necessary for the local document collection 100 to reside in a single folder or on a single server as long as their contents are accessible by the system's processing system for parsing. For example, some or even all of the documents could be located elsewhere, with at least part of the local document collection 100 comprising network addresses or other links to those remotely located documents.

A given collection of local documents 100 can be compiled and stored in a variety of ways. For example, documents specific to a given litigation (for example) matter can be stored in a single directory with a specific name. Firms that use system-wide document management systems may also already have tagged the bulk of its attorney work product repository with client matter numbers. The local document collection 100 can thus be grouped and analyzed and updated in accordance with the structure of the existing document management. Local documents also may be collected automatically through the use of “smart folder” software that collects all documents containing a certain characteristic (for example, all documents containing a client/matter sequence “C/M: 0004-2”). These “smart folders” are widely available and built into operating systems such as Mac OS X. The invention may also be implemented to automate the process of discovering local documents by going through the file directories on one or more designated servers and indexing the directories and files that contain signatures (using image or pattern-recognition routines) or specific keyword patterns corresponding to a particular litigation matter.

Embodiments of the invention could also work with what may be termed “near-local” documents that are neither specific to a matter at hand nor generally available. One example would be the litigation record for the same client, but in a different matter. For example, the client may currently be or have been the plaintiff in a separate infringement action relating to the same trademark, but against a different defendant. Many of the references and case citations in that previous litigation may be relevant to the matter at hand, but most of the local documents of the previous litigation will probably not be available except to those with access to the firm's document storage system. The documents of the other litigation could then be either searched and analyzed separately, or could simply be considered to be a segregated sub-set of the local documents 100 of the current case. Note that the near-local documents need not be from a concluded matter, but could be from concurrent litigation, maybe being handled by a wholly or partially different team of attorneys. Note that having the same client does not guarantee high relevance—for example, the two litigations may be taking place in different jurisdictions.

One feature of different embodiments of the invention is that the local documents need not be limited to those generated by the current user, that is, the user who wants the system to do a search. In fact, in most litigation, the local documents will be the result of work of more than one attorney. The invention therefore allows each user to benefit—in terms of improved search results—from the work of all, although, as is described below, the user can disable various parameters to tailor a search to immediate wishes.

One other feature of various embodiments is that searching need not be derived or launched based on an immediately open active document. In fact, as will be seen below, one aspect of the invention would make it possible for a user to initiate a search and to be presented with documents highly relevant to the matter she is working on without even having a document actively open at all. This is because embodiments of the invention can mine the local documents as a whole, that is, the entire current case record, to determine relevance and not just what the user has on her screen. Note that this is opposite to the trend represented by Budzik and to some extent also Lexis for Microsoft Word: These systems, relying as they do on active documents, suggest that the search system should try to get an ever tinier slice of what the user is looking at exactly at the moment of the search, presumably on the assumption that this is what the user most wants. Looking at the whole record, however, allows the user to freely traverse the record while maintaining the “hard-coded” context of the case.

### Mining the Local Documents

As will be apparent to those having ordinary skill in the art, the collection of local documents 100 can be mined in many different ways, including probabilistic classifiers that are trained to detect whether a case is a patent case, or a ruled-based analyzer that parses keywords in a document to derive the case number, the judge's name, and the party names. The local documents can also be manually mined, or can absorb pre-existing metadata tags from a third-party provider.

As even a cursory online search will show, there is an entire industry and body of academic research devoted to the topic of text and other data mining. There are even many commercially available software packages that mine data and text in particular fields such as the TIBCO Spotfire software products (for several different industries ranging from life sciences to energy to financial services). As another of very many examples of such software products, the Thomson Reuters company sells its Thomson Data Analyzer software as an interface for managing and extracting patent and scientific data within in-house or commercial databases. Those familiar with the various algorithms and techniques used in these and similar text-mining software systems will be able to choose which routines to include in any desired implementation of the various embodiments of this invention given the description of the use of local document tags found here.

As other document search systems do, the invention evaluates the relevance of the various global documents it examines by assigning to each document a “score” to determine its relevance ranking. Unlike other systems, however, the invention evaluates the relevance of global documents also as a function of to what extent they include tag words or phrases or images identified in the local documents 100.

For example, assume that the matter at hand is litigation relating to patent infringement. The local documents 100 can be then scanned for the presence of a sequence consistent with U.S. patents (for example, “#,###,###”, “RE##,###”, “U.S. Pat. No.” followed by a mixture of digits and punctuation marks, etc.). If the frequency of the patent-consistent sequence in the local documents 100 exceeds a pre-defined threshold, then the system will assume and classify that the litigation at issue is indeed a patent litigation matter. The presence of phrases such as “prosecution history estoppel” and “fraud on the Patent Office” will also almost certainly indicate that the matter relates to patent law. Ranking scores for patent cases may then be raised and the scores for state cases lowered since federal courts have exclusive jurisdiction in patent infringement cases.

Almost every type of professional matter will be recognizable by the presence of at least some terms, phrases, citations or formulas that occur almost exclusively in the context of such matters and that could be used as suitable tags. Few texts not written by those in the medical profession would use the word “metatarsophalangeal,” as another example. In other words, terms that are rare (low frequency) in general are relatively more common less in documents relating to the specialty that uses those terms.

Patent documents have other structures that are amenable for such text-processing techniques, including the subject matter classification, filing date, claim numbers and dependency between claims, contents of various sections including the abstract, background, and detailed descriptions, and claims. In many databases this information is in fact already identified as such, or even stored as separate fields for ready extraction. Alternative detectors for such structural components include classifiers that are trained on a large set of patent cases and non-patent cases. For instance, a combination of supervised and unsupervised clustering routines including Expectation-Maximization routines may be trained over features such as the frequency of “#,###,###” phrases, and the frequency of “U.S. Pat. No.” phrases, and the frequency of words such as “infringement,” “validity,” “invalidity,” and “issuance” to help predict (that is, help calculate a ranking score) whether a new document is a patent case or not.

Continuing with the example of patent infringement litigation, the local documents 100 can be scanned for the presence of sequences consistent with the name of a judge (for example, “Judge {name}” or “Honorable {name}” or “{name}, J”). By analyzing the local documents as a whole, the system can determine not just the presence or absence of a particular judge-specific sequence, but also the frequency with which that sequence appears in a given current collection of local documents. If a certain judge-specific sequence appears frequently enough to overcome a predetermined threshold, the system decides that the litigation at issue is being presided over by a certain judge. Ranking scores for cases with that particular judge are then raised.

In this example, the local documents 100 could also be scanned for the presence of sequences consistent with United States (or other, of course, depending on where the matter is taking place) Statutes (for example, “## USC ####”; or “§###”). Ranking scores for cases mentioning that particular statute are then raised. The local documents could also be scanned for the presence of sequences consistent with jurisdictions (for example, N.D.Cal. for “Northern District of California” or S.D.N.Y for “Southern District of New York”). Ranking scores for cases from the same jurisdiction and the corresponding appellate jurisdictions (for example, the Ninth Circuit for N.D. Cal. but not for S.D.N.Y.) are then raised.

Local documents 100 could also be scanned to determine whether the user is representing a plaintiff or a defendant. This can be achieved in a variety of ways including analysis of the pleading captions. Ranking scores for cases where a plaintiff prevailed (which could be determined by scanning for and analysis the judgment portion of the document), would be raised when plaintiff's attorney does the search; ranking scores for cases where a defendant prevailed would be raised when the defendant does the search.

Local documents 100 could also be mined for references to any of a set of words, characters/symbols or images corresponding to a certain category. For example, they might be scanned for the presence of biotechnology phrases such as “RNA” or “DNA” or “protein,” for the presence of a mathematical formula, a particular chemical structural formula, electronic circuit, radiologically imaged body feature, etc., of interest. Again, the phrases (alphanumeric, symbolic or image-based) may be learned through training on a database of biotechnology cases and non-biotechnology cases. A high frequency of these words, etc., in the local documents would allow the system to estimate that the litigation underlying the search is a biotechnology case as opposed to a computer software case. As the collection of local documents grows, the likelihood of false positives in the system's classification should diminish. Known techniques such as the support vector machine techniques may then be used to train the system to improve accuracy for each collection of local documents, especially when initialized with information the user will often have early on. For example, attorneys will usually know no later than when they receive a summons or complaint what many of the tags will be, such as the type of matter involved (patent, trademark, criminal, bankruptcy), the court (at least initially usually the one that issues the summons or that has taken the complaint), the main cause of action (infringement, conversion, tax evasion, etc.) and other relevance-determining words and phrases.

Embodiments of the invention could also be configured to extract tags not only from words, symbols, images, etc., themselves from a given document, but also from deeper levels of information that the tags represent or link into. For example, if the tag generator finds a reference (such as is found on the front page of most patents) to one or more patent classes, then this information could be used as an entry point for mining at the level of the class definition. A patent that has been classified in U.S. patent class D12/303 (with analogous International Class designations) relates in some way to a sailboat even if the word “sailboat” does not otherwise appear. The system could then increase the weight of tags relating to the term “sailboat.” Embodiments of the invention could therefore either pre-store for reference or have pre-stored links to databases or web sites that give the “taxonomy” of technology as defined in, for example, the patent classification codes.

The discovery in a local document (and/or user entry or selection) of certain tags could also be used in some embodiments to trigger user entry of some tag (or other) information could also be used to trigger inclusion of still other tags. For example, assume that an attorney types in a court docket number, or that the tag generator locates such a docket number in a local document, for example by its alphanumeric structure or because it is in a “docket number” field of a structured local document. The tag generator could then use that docket number as an entry into, for example, an online docket system such as PACER, whereupon it could pull and/or parse the docket entry. This would in turn enable this embodiment to extract contextual information for tags such as the name of the judge, jurisdiction, parties, nature of the suit (using the PACER taxonomy), etc. More sophisticated systems could then even determine at what stage of the litigation the case is at, if there is a pending motion that has not been responded to, etc.

Such standardized coded information exists and could be used to determine tags in many other contexts. For example, a standard “Explanation of Benefits” (EOF) or similar medical insurance form will typically include healthcare service codes that may indicate potentially relevant or even highly relevant tags. For example, if the tag generator discovers the code “36415” on an EOF, then it can deduce that this patient probably has had a “collection of venous blood by venipuncture (drawing blood)”, since 36415 is the American Medical Association's Current Procedural Terminology (CPT) code for this service. Similarly, if the taxonomy of treatment used in the U.S. “Medicare” system is stored or referenced, the tag generator would be able to deduce tags from the number “E0455”, which, in the Healthcare Common Procedure Coding System (HCPCS), indicates that an oxygen tent was provided. As another example, finding “E66.0” and “F32.0” on such a medical insurance form would tend to indicate that the person involved was diagnosed with “mild depression” (F32.0), possibly because of “obesity due to excess calories” (E66.0) because that is what these International Classification of Diseases (ICD) codes of the World Health Organization (WHO) signify.

In addition to automation techniques, updating and tagging collection of local documents 100 may also be achieved with user assistance. The system may provide a user interface to facilitate both the manual update and manual tagging of local documents at the same time. The system may provide a user interface (UI—graphical or otherwise) for a user to specify which records are initially entered as local documents, or which records are to be added to the current collection of local documents. The user may manually indicate which returns he prefers and which should be absorbed into the collection of local documents. The user could also be given the option to include or not include any currently open immediate documents in the set of local documents from which tags are generated. The user could also be given the option to select certain phrases in an open immediate document to be chosen as tag phrases; note that this is not the same as using selected words or phrases as simple keywords in a Boolean search query, since other tags will typically also be used to refine the search.

The UI may also include automated user feedbacks. As the user browses through the return records, the system may track and capture user attention to certain results automatically or manually. For example, if a user actively looks at a particular document or section of a document (with activity indicated by active keyboard or mouse actions) more than an average time, this may indicate increased interest and relevance. Another possible option would be for the processing system to record the navigation history of a user in updating and searching for records: The system may track which cases the user clicks on in the return set of a case query, and then gives weight to cases that have similar contents such as similar tag values or similar keyword patterns in performing the next search for the user.

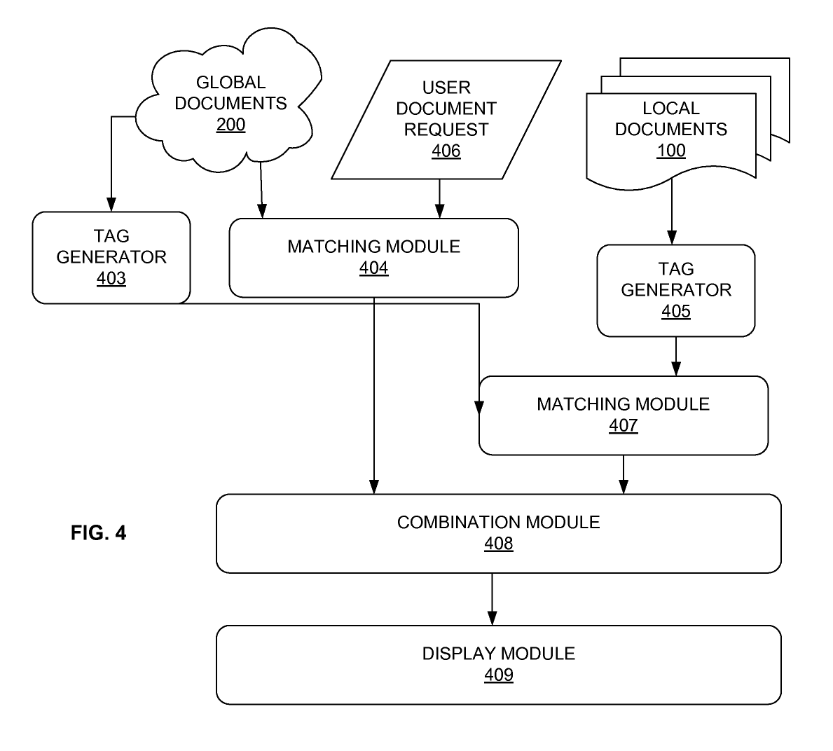

As a litigation progresses, the information that can be mined and coupled to a ranking routine grows. The system may thus be configured for adaptive learning. For instance, it can compare the relative frequency of certain categories of key words in a collection of local documents in determining whether to generate a particular tag value. For example, a tag-list generating module 405 (see FIG. 4) could compare the occurrences of biotechnology terms such as “DNA,” “RNA,” or “protein” with the occurrences of computer terms such as “software,” “microprocessor” or “Claude Shannon.” As the litigation records grow, the chance of false positives should diminish, such as assigning a tag value representing a biotechnology case to a computer case that happens to include the word “DNA” in a few instances in the initial set of litigation documents.

In general, the user will be in some way affiliated with the matter at hand, such as being an attorney on the matter's litigation team, and will be able to or is otherwise authorized to access the local documents. Global documents, in contrast, will be available even to those not affiliated with the matter.

Note that one embodiment of the invention might not require a user to be present at all. In this case, the search functions described here could be run automatically as a background operation, for example, according to a particular schedule or triggered by a change in the collection of local documents. When users begin actively working on the matter, the system may in this case already be able to provide them with at least some relevant information that they may not have been aware of. For example, another attorney's work from a precious evening might lead to a noteworthy change in which documents ranked by the system as being most probably highly relevant are presented most prominently to other members of the litigation team when they access the system.

### Applying Local Documents to a User Query

FIG. 4 illustrates one embodiment that uses local document 100 when executing a search based on a user-specified query. A local document-specific tag list may be generated by a tag generator 405 within the overall processing system 800 from the local documents 100 as a whole. The tags represent key characteristics of the litigation matter that a group of users are working on and are either automatically extracted by the tag generator 405, or are input via a user-input module 406, or both. For instance, the tag generator 405 may first scan an initial litigation complaint document and extract and store the party names, any asserted patents for patent infringement actions, causes of actions, the judge's name if any, the jurisdiction, the technological subject matter, etc. The tag generator 405 may then adjust the tag values or add additional tags as the collection of local documents grows to include additional documents of the litigation matter such as answers to the complaint, summary judgment motions, claim construction briefs, substantive rulings from the court, and so on.

For example, the tag generator 405 could continue to scan the first page of a brief and extract the title of the brief and spot key words such as “claim construction” to determine that the brief is of the claim construction” category. Knowing that it's a claim construction brief, the tag generator 405 may then search for a technology tutorial section of such a brief and heavily weight the words in that section to confirm or modify the subject matter of the collection of local documents. That the tag generator 405 takes into account of the growth of the collection of local documents has distinct advantages over limiting the coupling of the collection of local documents to just that fraction of the collection of local documents that happened to be at the user attorney's station or, for that matter, recently accessed by a given attorney. Another benefit of using a collection of local documents instead of just one or more current active documents is that it can minimize user-bias that arises from the unique nature of a professional searching.

Similarly, the tag generator 405 is applied to each document in a manually and/or automatically selected set of global documents 200 to extract their tag information so that it can be compared with the tags developed from the local documents 100.

There are different ways to specify which set of global documents 200 the processing system 800 is to search for relevant documents. One way would simply be for the attorney (physician, etc.) or the attorney's firm (or hospital or medical group, etc.) to maintain a list of external document sources along with the identifiers such as network addresses that the processing system can go to access the documents. For example, it would be natural for an intellectual property firm to assume that a patent database such as maintained by the US patent office or other private organizations should be included in the list of global documents. Litigators may also naturally think to include a database such as in the PACER system, etc. For each type of matter or circumstances, the attorney or firm could therefore establish and maintain a “search template” that includes, among other information, identifiers the processing system can use to determine which body of documents to use as the global documents.

The processing system 800 itself could also automatically identify likely relevant global documents given the set of tags that are determined for the local documents. For example, even a search of the Internet using a standard search engine with keywords such as the tags is likely to return web sites that may be of interest to the user if they are specific enough; such a search may in fact point to published articles, case analyses, and other information that may be very convenient for the attorney, but not otherwise easily accessible except through the Internet. Still other global documents could be selected by the user or pre-set in the system as known but still non-specific “standard” and often relevant references, such as Black's Law Dictionary

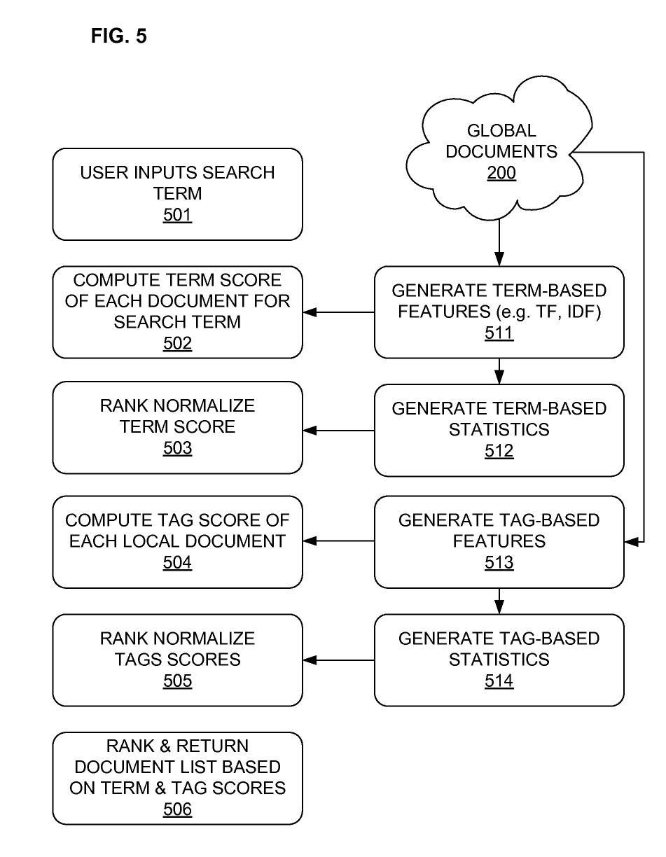

See FIG. 5. The collection of local documents is preferably (but not necessarily, for a fully automated implementation) used in combination with a user search query 501. The search query 501 may take on a variety of forms, including Boolean searches with “AND,” “OR,” “NOT,” adjacency operators, etc., and natural language searches where the user may construct queries in natural language.

One simple interface could be similar to the one used by the U.S. Patent Office itself, in which the user manually enters a Boolean expression. Other more sophisticated and convenient alternatives include more graphical input; for example, the user could be presented with a combination of on-screen fill-in fields (for example for the first entry of the docket or case number) along with various pull-down or other menus. For example, one pull-down menu could list “Type” with selections such as “patent,” “bankruptcy,” “environmental,” etc. Choosing “patent” could then be used to limit and simplify other menus; for example, if “patent” has been selected, then “Court” would need to list only federal courts, although an “other” category could of course be included. Once a court is selected, “Judge” could similarly be limited to those known to be serving in the particular jurisdiction, again with an “other” option in case of a judge who's not listed. Other possible entry fields could be “Client” and “Opponent”. If a previous client or opponent is selected or entered, then this in and of itself could indicate to the processing system the need to include documents from the other, previous matters as part of the local documents; in other words, this may identify “near-local” documents that should be searched. In general, the design of user interfaces for document search systems is well-understood and is therefore not described in further detail here.

In mining both the collection of local documents 100 and the global documents 200, the system constructs a set of dominant semantic concepts and associates them to the collection of local documents as tag values. The local documents' tag values are then used at step 504 to compute a raw relevance score in response to user query 501.

Assume by way of example that the processing system interrogates a common-law database, that is, a database of cases, which comprise or are part of the global documents 200. A ranking module 503 can then assign ranking scores to entries in that common law database based on a comparison between their tag information and the tag information of the collection of local documents tags generated at generator 405.

For instance, the local documents 100 may have a tag called Fed-or-State, whose value signifies whether the litigation matter is in federal court or state court. Each document in global documents 200 is then also analyzed to have a tag value of “Fed” or “state” for the Fed-or-State tag. A matching module 407 then compares the tag value of each document in the global documents 200 and the tag value of the collection of local documents.

In FIG. 4, tag generators 403, 405 and matching modules 404, 407 are shown as being separate modules. This is done merely to illustrate separate matching operations—one on the local documents 100 and another on the global documents 200. Both illustrated tag generators 403, 405 may be implemented as a single software module operating on two document input sets (local and global); a single body of code may also be used to implement matching and relevance estimation for the two different document sets.

One embodiment involves comparing whether a value tag associated with the local documents matches a value tag attached to a given entry in the global documents 200. In step 504, if the value is a match, a computer-implemented algorithm raises the ranking score for that entry and if the value is not a match, the algorithm can either diminish the importance of the global document as a responsive return or do nothing. Under the forgoing example of the Fed-or-State tag, if the result is a match, matching module 407 assigns a value of, for example, “1” and weights the value with a predetermined weight for this tag. The weight for such a tag can be pre-specified, or dynamically adjusted at time of the user query. In one embodiment, the weight of the Fed-or-State tag is less than the weight of tag Patent-Number. In other words, if a case or other document in global documents 200 contains the same patent number as that found in the local documents 100, the case will tend to receive a larger weighted matching score due to the heavier influence from the patent number matches.

According to one other optional aspect, a hard constraint may be placed on the Fed-or-State tag (or other tags, of course) so that only the cases matching the same court type are returned. Attorneys tired of clicking on “federal cases” all the time to access federal cases would benefit from seeing that states cases are automatically removed, without any user actions, when they enter their search terms for a case involving a patent. When these same attorneys search in a pro-bono (volunteer) state case, they would find that without any foraging the very same search term brings relevant state case to the top.

As FIG. 4 illustrates, one embodiment of the invention may search global documents based on both user input via manually entered keyword queries as well as also searching the global documents 200 for the presence of tag terms generated by analysis of the local documents. A combination module 408 may be then be included to combine the results of these two “search paths.” The keywords in the query can be matched with keywords in candidate documents in global documents 200 using known feature metrics generated at step 511 and used in matching module 404. Many routines are known for quantifying the relevance of a document given keywords; indeed, every time users perform an Internet search some such metric is being applied, and usually several. Many other techniques are known from the text-mining literature.

Just one of many possible examples of a metric that the processing system can use to quantify possible relevance uses both a term frequency (TF) score of the document as a whole and an inverse document frequency (IDF) score of the term itself.

The term frequency (TF) score can be represented as follows:

$${tf}_{i , j} = \frac{{n}_{i , j}}{{\sum }_{k} {n}_{k , j}}$$

where n_{i,j} is the number of occurrences of the i-th term in the j-th document, and the denominator is the sum of number of occurrences of all terms in the document. In short, the TF score quantifies an answer to the question: “How common is this term in this document?” Although “stop words” such as “a”, “an”, “the”, “small”, “many”, etc., will normally be filtered out immediately (only 800 words make up almost 50% of all words in written English and the most common 300 words make up almost 65%, and therefore are typically useless for determining relevance), in general the higher a TF score is, the more common the word is and the less uniquely characteristic it will tend to be.

The TF score may be further multiplied by another known score, called the inverse document frequency (IDF) score, which can be expressed as the natural log of the number of total documents in a global documents divided by the number of documents a term appears in:

$${idf}_{i} = log \frac{\vert D \vert}{\vert \{ d : {t}_{i} ∈ d \} \vert}$$

where |D| is the total number of documents in the set of global documents. The denominator is the number of documents where the term tᵢ appears. Note that to avoid division by zero, the denominator may be added with a small quantity, such as 0.1. The IDF score quantifies an answer to the question: “How common is this term in general, that is, globally, not just in a given document?” The rarer a term is, the greater IDF will be.

Multiplying TF by IDF has this effect on an overall score for a given candidate document: If a term in the document occurs relatively frequently in the particular document but is in general rare, then it will have a high score. A term that is used often in the candidate document but that is also common in the total body of global documents will, however, receive a lower total score.

In embodiments that use some form of minimum threshold, either of a function of the product of TF and IDF or otherwise, one common weakness of many existing search systems is reduced or eliminated. As an example, using pure keyword-based searching, a document such as “Good faith negotiation is in my DNA” spoken at a deposition could fool such conventional system into returning the document as being relevant, even though it might be completely irrelevant in a case involving biotechnology. In embodiments of this invention, however, a single occurrence of “DNA” in the record, that is, in the local document collection or in a global document being searched, would probably not suffice to overcome the relevance threshold and would be ignored.

TF and IDF scores are used in a matching module 404 and then combined with local documents' tag scores in a combination module 408. Module 404 in one embodiment computes the TF score for each document in global documents 200 in response to the i-th search term in a search query, and the IDF score for the i-th term. Module 408 in one embodiment combines a rank-normalized TFi,j score for the document with the rank normalized local document Tag_Score for the document, and then multiply the combined score with the IDF score for the i-th search term. This forms a single score for the i-th term in the search query for each document in the set of global documents 200. The process is repeated for all the terms in the search query. In one embodiment of module 408, the scores for all the terms are summed to form a single ranking score for the search query for each document in the set of global documents 200 reviewed.

Some tags generated from the local documents may be more indicative of relevance than others, and a module 512 may be included to implement this. One way to match local documents is through weighting mismatches between the local document tags outputted by tag generator 405 and the tag features of a candidate global document. Weighting can be computed in a step 513 as a function of, for example, the pair-wise distance between tags. The weights on different tags may be pre-specified or adjusted dynamically by the user. Tags may therefore be weighted to indicate different levels of importance. The weights on different tags may be pre-specified or adjusted dynamically by the user. For example, in one setting of a prototype of the invention, if the patent number(s) of a global document case matched one or more patent numbers in the local documents, then the matching score was increased relative to other matches. The weights can then be summed and normalized to a single score to reflect a degree of similarity between the collection of local documents and any given candidate case:

$$Local\_Document \_Tag \_Score = \frac{{\sum }_{a ∈ A} f ( a ) w ( a )}{{\sum }_{a ∈ A} w ( a )} ,$$

where w(a) is a weight assigned to matching of tag a using matching function ƒ(a). ƒ(a) can, for example, be a Boolean test returning 1 if the feature exactly matches (for example when both the collection of local documents and the particular document being considered fall under the same jurisdiction) or a number reflecting partial matches (for example when the collection of local documents has a party name The Regents of University of California, and the particular document being considered has a part name Univ. of Cal.). The different matching functions ƒ(a) may be normalized using known techniques so that each returns a result that falls within the same dynamic range, for example [0,1].

It is recognized that automated tagging of the collection of local documents may not be perfectly accurate. The matching function ƒ(a) may be adopted to accommodate unknown tag contents, or tag contents that have associated probability scores. One way to deal with unknown tag contents is to eliminate the particular tag in local documents matching. Another way is to fold the probability score of the tag having a certain tag value into the overall matching score.

The weights w(a) may be pre-defined or dynamically adjustable at run time. The weights reflect that different tags carry different contributions to the overall ranking of a particular document. For instance, the patent number tag maybe assigned a relatively high weight as cases dealing with the same patent in most circumstances should always be returned. The system may be initialized with a set of weights that have been determined to be user-intuitive based on studies of behaviors and expectations of users. For instance, attorney users generally value greatly records that are issued from the same judge, records that pertain to the same jurisdiction and corresponding appellate bodies, records that have the same party names either as plaintiff or defendant, and records that deal with the same patent number. Attorney users also value in a relatively lesser degree records that fall within the same technical subject matter.

In another embodiment, attorney users of the system can adjust ranking weights for various purposes at run time or deployment/configuration time. For example, and without limitation, an attorney seeking to find cases in any jurisdiction concerning drug patents could adjust the ranking algorithms so as to place greater weight on patent/non-patent distinction or software/biotech distinction. On the other hand, the attorney user might lower the weight given to the “same jurisdiction”/“different jurisdiction” distinction if the task at hand is to survey sister jurisdictions for similar fact patterns. Under that scenario, matching module 407 receives and processes user inputs to adjust its weights as entered from a user interface with which the attorney user can visualize the existing weights and provide adjustment inputs. In one embodiment, the user has the option to make the distinction a hard constraint so that only cases detected as bearing patent and biotech tags are returned from a user query.

Any of many different techniques may be implemented in any given design of the invention to enable convenient user adjustment of tag weights, if this feature is even included. Just one of many examples is described in U.S. Pat. No. 6,014,661 (“System and method for automatic analysis of data bases and for user-controlled dynamic querying”). In this data-mining system, a user is presented with various onscreen graphical devices such as sliders, alphasliders, etc., and as he adjusts the settings of these, the underlying ranges and weights they represent are adjusted correspondingly. For example, various tags could be presented as sections of a “pie-chart whose “slices” can be adjusted in size. Changing the size of a tag's displayed “slice,” for example by using a cursor to drag a point on the circumference of the pie shape, then adjusts its weight correspondingly.

Having computed a keyword-based matching score and tag-based matching score in modules 502 and 504, the system in one embodiment combines the scores. One way to combine them is by using a technique known as rank normalization, in steps 503 and 505. The idea is that the two features may not be correlated and their statistical distribution may not be known or easily modeled as a parametric model such as having a mean and a variance. Because of the lack of a priori knowledge of the distribution model or lack of reliable estimation of a parametric model, the system may use rank normalization to help model the distribution(s). Rank normalization can be expressed as follows.

$${x}_{i}^{′} = \frac{\vert \{ {y}_{i} ∈ B : {y}_{i} < {x}_{i} \} \vert}{\vert B \vert}$$

where xᵢ is un-normalized data, B is a collection of already-observed data points, and yᵢ is an unnormalized data member within B. x′ is the transformed or normalized data, for example, the output of step 503 and step 505. The normalized data falls in a range of [0,1].

In one embodiment, B is collected from the global documents in steps 512 and 514. For instance, step 512 in one embodiment collects all term frequency scores for all word phrases in global documents 200. In one embodiment, the system first gathers a large sample set from the global documents to construct the set B. The system then derives a uniform histogram with variably spaced histogram bins to model the distribution of B. The histogram values are normalized to take a sum value of 1. This form of histogram equalization approximates the statistical distribution of the values in collection B and allows for fast computation of rank normalization steps 503 and 505.

In an alternative embodiment of 503 and 505, the rank normalization score may be achieved in accordance with the following algorithm, expressed using the Python programming language, taking into account all samples, or representative samples, in the collection set B. The function below takes a collection of previously-observed samples in set B and a currently observed data point x as inputs. It uses a filter that discovers how many samples in set B fall below x in value, and returns the ratio of the number of samples falling below x and the total number of samples in B.

def rank normalization (x, B):

def lessthan(y): return (y<=x)
a = filter(lessthan, B)
return (float(len(a))/ float(len(B)))

One benefit of using the rank normalization is the ability to capture in a non-parametric manner the underlying statistical distribution of the feature metrics. Another benefit of using the rank normalization is that disparate features may be normalized to fall within the same dynamic range, for example, [0,1]. This facilitates combination of disparate features. Compared to some other manners of feature normalization, rank-normalization has the advantage of being non-negative and monotonically increasing. Thus, the normalized score corresponds well to certain feature metrics such as TF scores and the weighted local document tag matching scores, which exhibit the same characteristic. A combination module 408 may therefore be implemented so as to combines the rank normalized scores on various features. Module 408 can be implemented in many ways including the summation of the natural log of each of two or more rank-normalized scores.

Of course, the example of rank normalization just discussed is but one of many known ways to combine the results of different scores computed for a single set of text-mined documents. Those familiar with data-mining literature and search technology will be able to choose which algorithm best suits their needs in any given implementation of this invention.

Another way to combine the features is to first sum over the features that are document-specific, such as the TF score for a term against a document, and the collection of local documents weighted-mean score against a case, and then the sum is multiplied by the IDF score of the term against the global documents. Such resultant combined score for each of the multiple search terms a user supplies in a query can then be further combined to form a single score for each entry in the set of global documents under the query. Yet another way to implement module 408 is to first rank the list of returns along each feature dimension, and then the top N (for example, N=5) results from each dimension is returned and aggregated and presented to a display module 409 to be displayed to the user. Here, a “dimension” would correspond to one tag term.

A person of ordinary skill in the art will appreciate that there exist other ways than the above specific embodiments to measure the distance between the components of a user query and the global documents at step 502, and to quantify, at step 504, how well the collection of local documents and the global documents match, and to combine the matching scores at step 506.

For example, in one embodiment of a module implementing step 506, the system allows the user to turn off the collection of local documents matching completely for certain tasks and re-enable it for others. Using such an embodiment, the user may decide to perform document queries purely based on his/her own query terms by turning off local documents matching. In other words, the user may disable the 100→405→407 search path. This could be useful when the user decides to move away from the context of the collection of local documents, and desires to see results free from the influence of the context of the litigation matter.

As another option, the user might be allowed to temporarily disable certain local document tags such as “Technical Subject Matter,” while leaving others active; this would have the effect of treating the technology as a neutral factor in ranking returned cases. Yet another example is that the user could be permitted to disable certain local document tags Jurisdiction, while increasing the weight for other tags such the “Technology Area”. The user might do this where, for example, she desires to see how a particular technology has been handled across jurisdictions. The result will be that the result list returned for a given search entry will bring back cases with the same underlying technology at the top, regardless of jurisdiction.

The processing system may also be configured to allow the user to adjust matching parameters in step 504 dynamically at run-time. In this case, the system user interface may also provide input to the matching module 407, which receives and processes user adjustments on the weights and adjusts its internal weights accordingly. Further, the system may compute rank based on a mixture of local documents tags and components of a user query. Alternatively the system may compute rank based on the components of a user query first, then re-rank a portion of the return set (for example, only cases that contain the search term) based on the local document tags. The re-rank option in this example ensures that the top returns contain the search term that the user specifies. In contrast, the mix-rank option (where the system combines ranking scores based on collection of local documents tags, and scores based on user-specified query terms) may return cases that do not contain the exact user-specified query term. The mix-rank option may provide a more intuitive return set and better tolerate typos in user search terms.

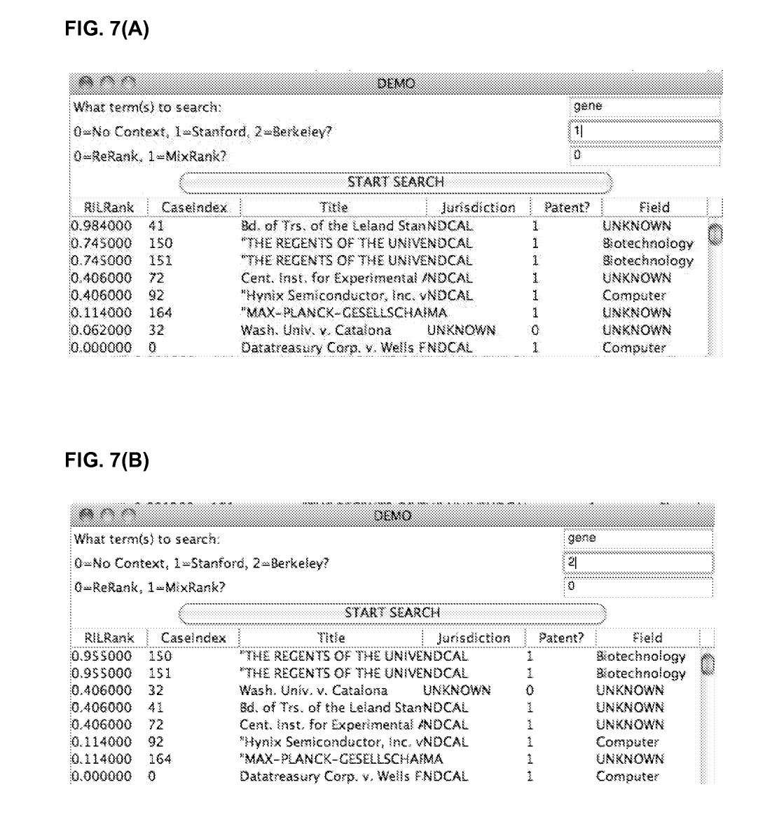

FIGS. 7(A) and 7(B) illustrate a run of a prototype of one embodiment of the invention. In this run, the user searched for the word “gene” in a legal opinion database and the system returned five cases that have the word based on the term frequency score of the term “gene.” FIG. 7(A) demonstrates the intuitive return results based on a Stanford collection of local documents, and 7(B) demonstrates another set of intuitive return results based on a Berkeley collection of local documents.

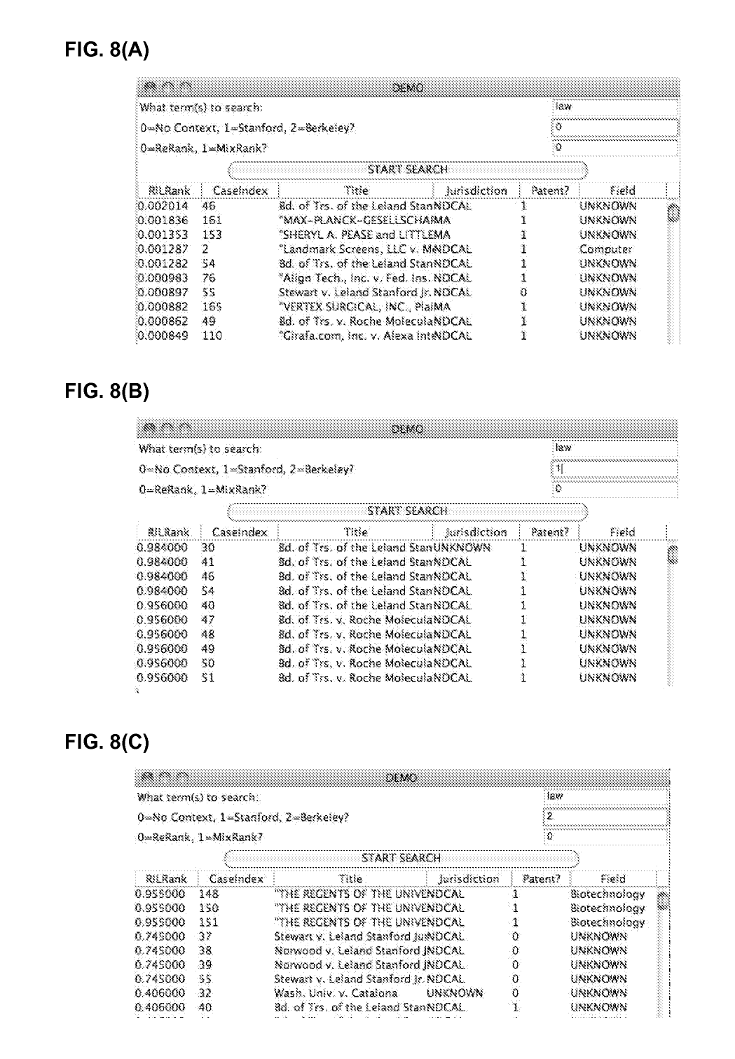

Unlike the keyword query whose results are illustrated in FIGS. 7(A) and 7B, FIGS. 8(A)-(C) demonstrate a user query based on a more common word “law.” FIG. 8(A) shows returns based on TF and IDF scores of the word only when there is no litigation context. In comparison, FIGS. 8(B) and 8(C) return more intuitive results, in the context of a Stanford collection of local documents, and Berkeley collection of local documents respectively. Thus, FIGS. 7(A), 7(B) and 8(A)-8(C) show that upon detecting that the collection of local documents is a Stanford v. Roche litigation that deals with biotechnology and a patent, the cases that have the word are reranked based on how similar they are to the collection of local documents and cases that have Stanford as a party and similar technology maters are preferred and ranked on the top.

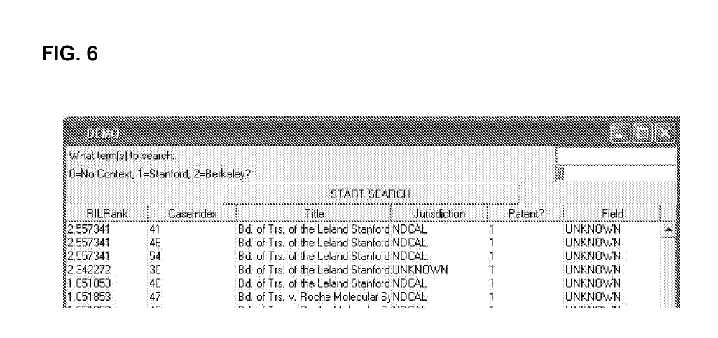

Similarly, upon detecting that the collection of local documents is switched to a Univ. California Berkeley one, the same cases that have the word “gene” are reranked and the cases that are similar to the local documents appear on the top. As an additional example of collection of local documents selection, FIG. 6 illustrates how, without any user query, the awareness of local documents aids in organization and ranking of global documents comprising legal opinions. There, the user selects a collection of local documents relating to Stanford litigation, in particular a Stanford v. Roche case with a patent claim in the biotechnology area before the N.D Cal. federal court. Without any user query, the system was able to rank the cases found among the global documents 200 based on the local documents' tags and tag values. As shown in FIG. 6, cases that have Stanford as a party, deal with a patent claim, and also belong to the N.D. Cal. court are automatically ranked on top and displayed.

Refer to FIG. 5. Upon compiling the ranking scores for a query, the system may then sort and display the query returns in descending order of ranking scores in step 506. In displaying the query return, the system may adjust the display characteristics of the return results to reflect the different ranking scores of the return, including displaying results in different colors or fonts or font sizes in accordance with the ranking score for each record return. The system may divide the return set into pre-defined categories or apply user-specified filters on the return set. The system may also provide drill-down options for the user to easily break up the return set into sub-categories for easier visualization. For example, the user may want to review only expert reports in the return, or only patent cases, or only cases by a certain judge. Once the system has found, scored, ranked and displayed its notion of relevant documents, any known technique may be chosen to allow the user to further narrow and refine the list of documents she is presented with.

As will be apparent to those having ordinary skill in the art, the example embodiments disclosed can be useful for a range of professional search and record management task. For example, and without limitation, the medical charts of patients can be mined and coupled to a medical literature search engine in such a way as to allow patient-specific rankings. By way of illustration only, if the chart indicates that a patient is a female, this information can be readily coupled to the medical literature database so as to increase ranking scores for articles concerned with women's health issues. Other aspects of a patient may be handled similarly, including, by way of example, the patient's age, ethnicity. Any patient-specific information that can be digitally encoded can potentially be harvested in such a system. In all cases, the underlying elements and principles disclosed remain the same for other fields of professional search and record management.

An attorney user using the example embodiments will typically start at a user interface such as depicted in Figure. This simple example of a user interface contains a search bar for entry of a search query and icons representing the different client/matters that the attorney user and others are working on. As is common, an attorney working on Matter X may select that matter by clicking on an associated icon. When the attorney selects the matter, the processing system then associates or links to the collection of local documents specific to that matter. The cases returned from a user query for “law” (given other tags including “Stanford” and “Berkeley”) each carry a ranking score, which is shown under the arbitrary score label “RILRank” in FIGS. 7(A), 7(B) and 8(A)-8(B). In other embodiments, the matter may be pre-selected. By selecting a certain matter, the attorney essentially tells the system which set of local documents tags to use in determining final ranking scores.

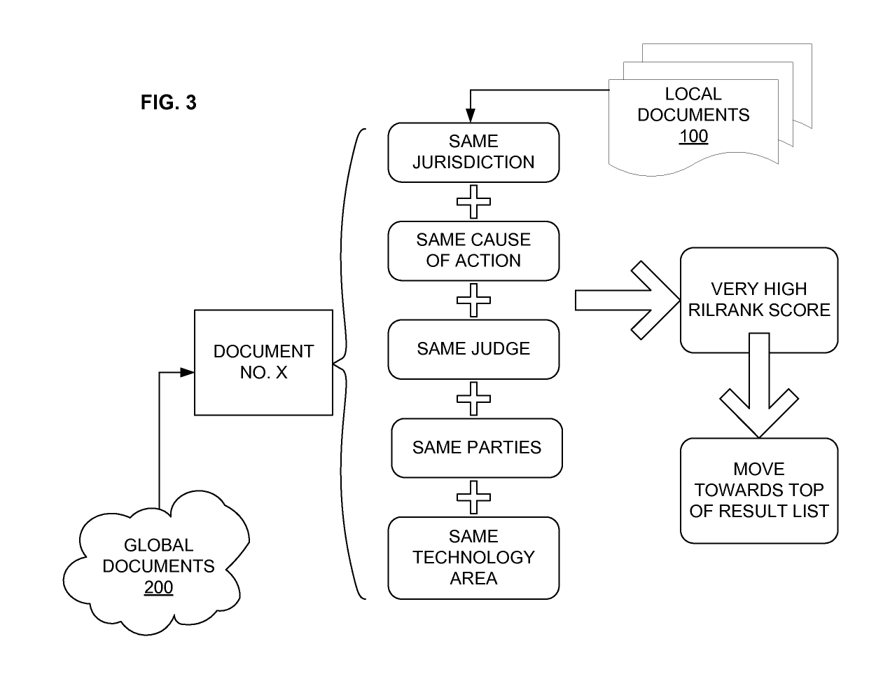

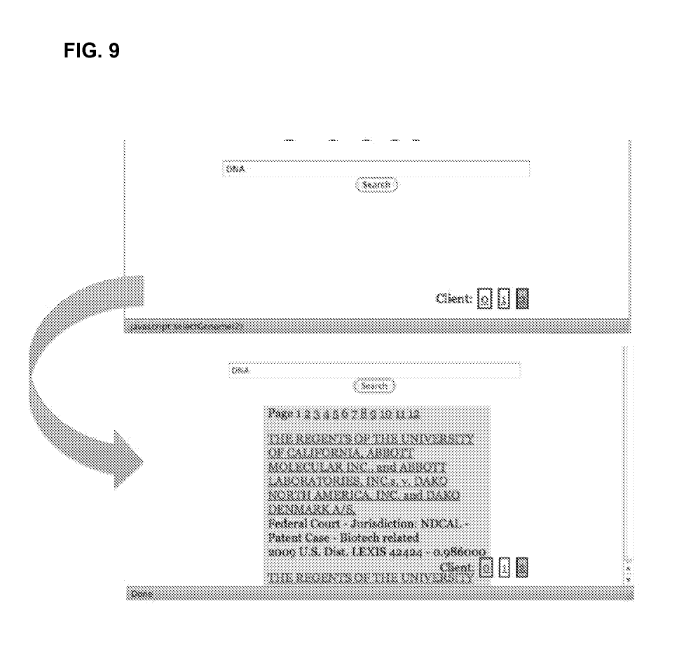

Once the matter is selected, the attorney may simply enter her query and launch the system, for example by clicking on a “Search” icon. At this point the system, in one embodiment, retrieves and ranks cases (or other documents) that contain the search term, and re-ranks the resulting hit list as explained above. The attorney is then presented with a list of cases. This list presents an intuitive selection of cases to the attorney query because the result list reflects the particular needs of the particular client and matter at issue as defined by the tags that will have been generated from the local documents. FIGS. 3, 7(A), 7(B) and 8(A)-8(C) illustrate how a case that matches along multiple dimensions (patent case, same or similar party name, biotechnology, etc.) is ranked higher than a case that matches only along fewer or no dimensions. The user can then click on a given case name, whereupon the system preferably retrieves and makes available the full text of the case, or at least whatever document corresponds to the displayed listing. For example, FIG. 3 is a conceptual illustration of one embodiment of how a given case is retrieved from a database of global documents of common law cases and assigned a score. In FIG. 3, this score is shown with the name “RILRank” merely because this is the name that was assigned to this value in one prototype whose results are depicted in FIGS. 6-9; there is no other significance to this name. Because in this instance Document No. X shares with the litigation at hand five legally relevant similarities (same jurisdiction, same claim at issue (for example, patent infringement), same underlying technology, same parties, and same judge), Document No. X in this instance would receive a high ranking score. Document No. X would consequently be ranked higher than others cases that lacked such similarities and would, accordingly be moved higher in the result list presented to the user.

### Machine Architecture

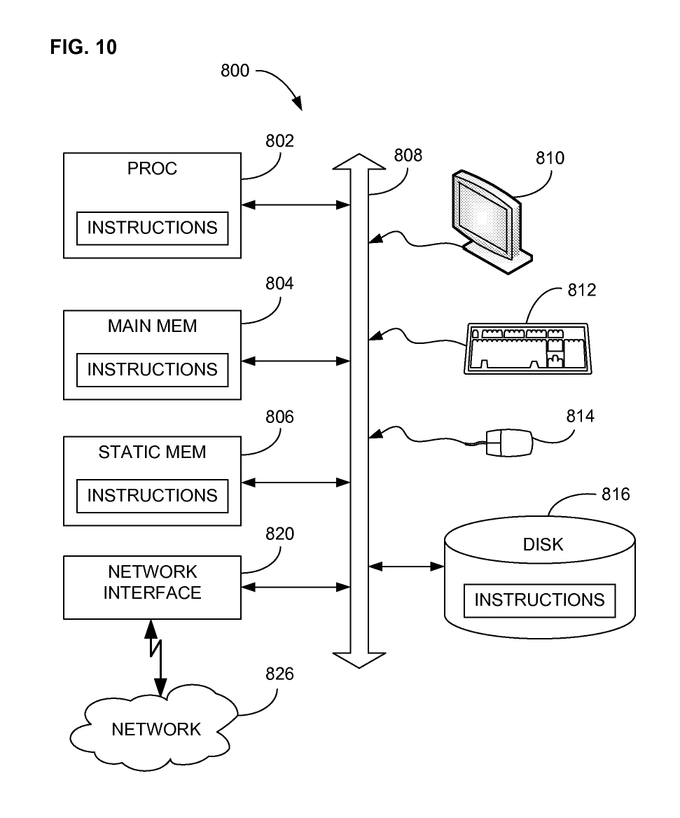

FIG. 10 shows a diagrammatic representation of a machine in the example form of a computer system 800 within which a set of instructions, for causing the machine to perform any one or more of the methodologies discussed herein, may be executed. As should be clear from the description above, the various extraction and analysis modules 403-409 may be implemented as bodies of executable code to control the processing system and carry out the various operations described.

In alternative embodiments, the machine operates as a standalone device or may be connected (for example, networked) to other machines. In a network deployment, the machine may operate in the capacity of a server or a client/user machine in a server-client/user network environment, or as a peer machine in a peer-to-peer (or distributed) network environment. The machine may be implemented in any suitable computer such as a serve, a client-user computer, a personal, tablet, laptop, palm-top computer (PC) or tablet computer, a Personal Digital Assistant (PDA), a cellular telephone or other mobile device, a web appliance, a network router, switch or bridge, or in general any machine capable of executing a set of instructions (sequential or otherwise) that specify actions to be taken by that machine, that can perform the operations described here, and that can present results to a user.

Further, while a single machine is illustrated, the term “machine” shall also be taken to include any collection of machines that individually or jointly execute a set (or multiple sets) of instructions to perform any one or more of the methodologies discussed herein.

The example computer system 800 includes a processor 802 (for example, a central processing unit (CPU), a graphics processing unit (GPU), or both), a main memory or storage system (such as a hard disk, solid state or spinning) 804 and a static memory 806, which communicate with each other via a bus 808. The computer system 800 may further include a video display unit 810 (for example, a liquid crystal display (LCD) or a cathode ray tube (CRT)). The computer system 800 also includes an input device 812 (for example, a keyboard), a cursor control device 814 (for example, a mouse), a disk drive unit 816, a network interface device 820, and other standard system and peripheral components as needed.

The disk drive unit 816 includes a machine-readable medium 822 on which is stored one or more sets of instructions (for example, software 824) embodying any one or more of the methodologies or functions described herein. The instructions 824 may also reside, completely or at least partially, within the main memory 804, the static memory 806, and/or within the processor 802 during execution thereof by the computer system 800. The main memory 804 and the processor 802 also may constitute machine-readable media.

The instructions 824 may further be transmitted or received over a network 826 via the network interface device 820.

While the machine-readable medium 822 is shown in an example embodiment to be a single medium, the term “machine-readable medium” should be taken to include a single medium or multiple media (for example, a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present embodiments.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure.

What is claimed is:

1. A method for finding documents relevant to a current matter comprising:
extracting from a collection of local documents at least one tag that is characteristic of the current matter;
searching global documents and estimating the relevance of each global document as a function of a measure of a degree inclusion of the tags;
presenting indications of the global documents having the highest estimates of relevance to a user;
said local documents being pre-identified as being associated with the current matter and including at least one document not actively and directly being processed by the user; and
said global documents both having a priori unknown relevance to the current matter and being accessible both to users associated with the current matter and to other users.

2. A method as in claim 1, in which the local documents are parsed automatically to identify and extract tags.

3. A method as in claim 1, in which at least one tag is extracted automatically from the local documents, that is, without user selection.

4. A method as in claim 1, further comprising sensing user input of at least one tag and including each user-input tag in estimating the relevance of each global document.

5. A method as in claim 1, in which the tags are digitally recognizable, digitally encoded sequences corresponding to information occurring relatively more prevalently in reference to the current matter than in general contexts.

6. A method as in claim 5, in which the tags are non-alphanumeric.

7. A method as in claim 5, in which the current matter is a legal matter and the local documents comprise a record of documents relating to the legal matter.

8. A method as in claim 7, further comprising accumulating and updating the local documents over time in which the current matter is a legal matter and the local documents comprise a record of documents relating to the legal matter.

9. A method as in claim 7, in which the global documents include a database of common-law cases.

10. A method as in claim 7, in which the current matter relates to healthcare matter and the local documents comprise a record of documents relating to at least one patient.

11. A method as in claim 5, in which at least one tag is an indicators in a classification system, further including automatically extracting additional tags from the classification system in accordance with the tag that indicated the classification system.

12. A method as in claim 1, further comprising automatically accessing the global documents via a publicly accessible network.

13. A method as in claim 12, in which the network is the Internet and the global documents include web pages.

14. A method as in claim 1, further comprising, for each global document and each tag,
computing a first prevalence value corresponding to the prevalence of each said tag in that global document and a second prevalence value corresponding to the prevalence of each said tag in a representative plurality of the global documents; and
estimating the relevance of each global document as a function of the first and second prevalence values.

15. A method as in claim 14, further comprising
receiving user indication of the relative importance of the tags; and
weighting the tags relative to their degree of indicated importance in computing the prevalence values.

16. A method as in claim 1, in which:
the current matter is a legal matter;
the local documents comprise a record of documents relating to the legal matter;
the global documents include a database of common-law cases; and
the tags are digitally recognizable, digitally encoded sequences corresponding to information occurring relatively more prevalently in legal-related texts than in general contexts.

17. A method as in claim 16, in which the tags include at least one of a case name, a case docket reference, a name of a judge, a name of a party, an indication of a jurisdiction, and an indication of a matter type.

18. A system for finding documents relevant to a current matter comprising:
a processing system that is configured
to receive data from and present data to a user;
to access and process data in a collection of local documents stored in at least one storage device, said local documents being pre-identified as being associated with the current matter and including at least one document not actively and directly being processed by the user;
to access a collection of said global documents, said global documents both having a priori unknown relevance to the current matter and being accessible both to the local processing system and other users;
a tag generation module comprising computer-executable code for the local processing system for extracting from the collection of local documents at least one tag that is characteristic of the current matter;
a matching module analyzing each of the global documents and estimating the relevance of each global document as a function of a measure of a degree inclusion of the tags;
a display module presenting indications of the global documents having the highest estimates of relevance to the user;

19. A system as in claim 18, in which the tag generation module is configured for sensing user input of at least one tag, said matching module then including each user-input tag in estimating the relevance of each global document.

20. A system as in claim 18, in which the tags are digitally recognizable, digitally encoded sequences corresponding to information occurring relatively more prevalently in reference to the current matter than in general contexts.

21. A system as in claim 20, said tag generation module being configured to recognize and extract non-alphanumeric tags.

22. A system as in claim 20, in which the current matter is a legal matter and the local documents comprise a record of documents relating to the legal matter.

23. A system as in claim 22, in which at least a portion of the global documents is accessed from a database of common-law cases.

24. A method as in claim 20, in which the current matter relates to healthcare matter and the local documents comprise a record of documents relating to at least one patient.

25. A system as in claim 18, further comprising a network connection device enabling automatic accessing of the global documents via a publicly accessible network.

26. A system as in claim 25, in which the network is the Internet and the global documents include web pages.

27. A system as in claim 18, in which the matching module is configured, for each global document and each tag,
for computing, for each global document and each tag, a first prevalence value corresponding to the prevalence of each said tag in that global document and a second prevalence value corresponding to the prevalence of each said tag in a representative plurality of the global documents; and
for estimating the relevance of each global document as a function of the first and second prevalence values.

28. A system as in claim 27, said matching module being further configured for receiving user indication of the relative importance of the tags and for weighting the tags relative to their degree of indicated importance in computing the prevalence values.
